(19) United States
(12) Patent Application Publication
(10) Pub. No.: US 2026/0214318 A1
(43) Pub. Date: Jul. 23, 2026

(54) IMAGE PROCESSING SYSTEM, IMAGE PROCESSING APPARATUS AND METHOD OF CONTROLLING THE SAME, AND STORAGE MEDIUM

(71) Applicant: CANON KABUSHIKI KAISHA, Tokyo (JP)

(72) Inventor: Atsushi GOTO, Kanagawa (JP)

(21) Appl. No.: 19/439,630

(22) Filed: Jan. 5, 2026

(30) Foreign Application Priority Data
Jan. 20, 2025 (JP) 2025-007981

(51) Int. Cl. H04N 23/61; H04N 23/63; H04N 23/67

(52) U.S. Cl. CPC H04N 23/61; H04N 23/63; H04N 23/67

(57) ABSTRACT

An image processing system in which an image capturing apparatus that captures a subject and an image processing apparatus that processes an image captured by the image capturing apparatus are communicably configured, wherein the image processing apparatus includes a first detection unit that detects a feature point of the subject or a line segment connecting feature points from the image, a second detection unit that detects a type of the subject from the image, an acquisition unit that acquires information on a measurement position of the subject based on the type of the subject; a determination unit that determines the measurement position of the subject based on the feature point or the line segment and the information on the measurement position; and a calculation unit that calculates an actual dimension between the measurement positions.

### BACKGROUND

### Field of the Technology

The present disclosure relates to an image processing system for measuring a dimension of a subject.

### Description of the Related Art

The operation in the e-commerce (EC) industry includes tasks called "shooting", "measuring", and "copywriting", and accuracy and productivity are major issues.

Among them, known measurement is performed manually, and unevenness in measurement by an individual and a large work load are major issues.

Japanese Patent Laid-Open No. 2019-99960 discloses an input support technique of measurement information using a voice recognition technique for work load reduction.

However, in the known technique disclosed in Japanese Patent Laid-Open No. 2019-99960 described above, measurement needs to be performed by selecting two points manually, and a work load occurs.

### SUMMARY

The present disclosure has been made in view of the above-described problems, and provides an image processing system that can reduce a work load in a case of measuring from a captured image.

According to an aspect of the present disclosure, there is provided an image processing system in which an image capturing apparatus that captures a subject and an image processing apparatus that processes an image captured by the image capturing apparatus are communicably configured, wherein the image processing apparatus includes at least one processor or circuit and a memory storing instructions to cause the at least one processor or circuit to perform operations of the following units: a first detection unit that detects a feature point of the subject or a line segment connecting feature points from the image; a second detection unit that detects a type of the subject from the image; an acquisition unit that acquires information on a measurement position of the subject based on the type of the subject; a determination unit that determines the measurement position of the subject based on the feature point or the line segment and the information on the measurement position; and a calculation unit that calculates an actual dimension between the measurement positions.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a configuration of an image processing system according to a first embodiment of the present disclosure.

FIG. 2 is a hardware configuration diagram of an image processing apparatus.

FIGS. 3A and 3B are flowcharts showing an operation of the image processing system.

FIG. 4 is a view illustrating an example of feature point position detection.

FIG. 5 is a view illustrating an example of subject type detection.

FIG. 6 is a view illustrating an example of a measurement position set table.

FIG. 7 is a view illustrating an example of a measurement position flat sketch table.

FIG. 8 is a view illustrating an example of display on a display unit of the image capturing apparatus.

FIG. 9 is a view illustrating an example of display on the display unit of the image capturing apparatus.

FIG. 10 is a view illustrating a configuration of a Web system according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

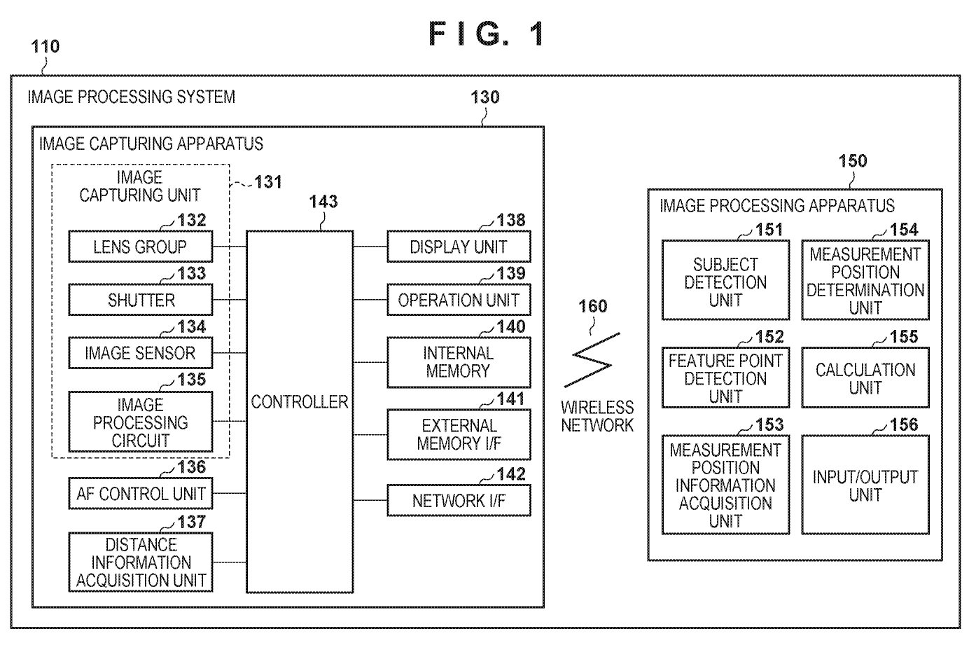

FIG. 1 is a view illustrating a configuration of an image processing system 110 according to the first embodiment of the present disclosure. In FIG. 1, the image processing system 110 includes an image capturing apparatus 130 and an image processing apparatus 150, and these apparatuses are communicably configured.

The image capturing apparatus 130 is a digital camera used to shoot a product or the like (hereinafter, called a subject) to be posted on e-commerce by a user. The image processing apparatus 150 is an apparatus that processes an image and distance information acquired by the image capturing apparatus 130.

Next, functional configurations of the image capturing apparatus 130 and the image processing apparatus 150 will be described.

### Functional Configuration of Image Capturing Apparatus

First, the functional configuration of the image capturing apparatus 130 will be described. As described above, the image capturing apparatus 130 performs shooting of a subject based on a user's operation on the image capturing apparatus 130. In the present embodiment, a case where the image capturing apparatus 130 is a digital camera will be described.

The image capturing apparatus 130 includes an image capturing unit 131, an autofocus (AF) control unit 136, a distance information acquisition unit 137, a display unit 138, an operation unit 139, an internal memory 140, an external memory I/F 141, a network I/F 142, and a controller 143.

The image capturing apparatus 130 may be a digital still camera or a digital movie camera. For example, it may be a mobile phone, a smartphone, a tablet, or the like. The image capturing apparatus 130 is preferably a portable device that can be held by the user, but is not limited to this.

The image capturing unit 131 includes a lens group 132, a shutter 133, an image sensor 134, and an image processing circuit 135.

The lens group 132 forms an optical image of the subject on the image sensor 134. Here, the image sensor 134 includes a charge-storage-type solid-state image sensor such as a CCD or a CMOS element that converts an optical image into an electric signal. The lens group 132 internally includes an aperture for determining an aperture value for adjusting an exposure amount.

The shutter 133 performs exposure to the image sensor 134 and light shielding by an opening and closing action, and controls a shutter speed. Note that the shutter is not limited to a mechanical shutter, and an electronic shutter may be used. In an image capturing element using a CMOS sensor, an electronic shutter first performs reset scanning for reducing a stored charge amount of a pixel to zero for each pixel or for each region including a plurality of pixels (e.g., for each line). Thereafter, it performs scanning for reading out a signal after a predetermined time elapses for each pixel or each region that has been subjected to the reset scanning.

The image processing circuit 135 performs image processing on RAW image data output from the image sensor 134. The image processing circuit 135 performs various types of image processing such as white balance adjustment processing, gamma correction processing, color interpolation or demosaicing processing, and filtering processing on the image (RAW image data) output from the image sensor 134 or data of an image signal recorded in the internal memory 140 described later. It performs compression processing with a standard such as JPEG on data of an image signal captured by the image sensor 134.

The AF control unit 136 extracts a high frequency component of an image capturing signal (video signal), searches for a position of a focus lens included in the lens group 132 where the high frequency component is maximized, controls the focus lens, and automatically adjusts the focus. This focus control method is also called TV-AF or contrast AF, and has a feature in which highly accurate focusing can be obtained. Note that the focus control method is not limited to the contrast AF, and may be phase difference AF or another AF method. Note that the lens group 132 may be a zoom lens.

The distance information acquisition unit 137 acquires distance information (subject distance) from the image sensor 134 to the subject from the position of the focus lens obtained by the contrast AF performed by the AF control unit 136, and stores the distance information into the internal memory 140. Note that the subject distance may be obtained not only from the contrast AF but also from the position of the focus lens obtained by phase difference AF or the like.

The image sensor 134 may be configured to have a plurality of photoelectric conversion regions in a pixel, and acquire two images formed by light fluxes that have passed through different pupil regions.

Such a configuration can acquire images (hereinafter, "A image" and "B image", respectively) generated by light fluxes that have passed through different pupil regions. Then, the pupil region corresponding to the A image and the pupil region corresponding to the B image are eccentric in different directions from each other from the pupil center along an axis called a pupil division direction. The distance information acquisition unit 137 may acquire the distance to the subject by converting an image shift amount due to this eccentricity into a defocus amount via a predetermined conversion coefficient and converting the defocus amount into a distance value. Alternatively, the distance value may be acquired based on the image shift amount. According to such a method, unlike a known contrast method, it is not necessary to move the lens in order to measure the distance, and therefore distance measurement at high speed and with high accuracy is possible.

Alternatively, the distance information acquisition unit 137 may use a system using a time of flight (TOF) sensor. The TOF sensor is a sensor that measures a distance to an object based on a time difference (or phase difference) between a transmission timing of an irradiation wave and a reception timing of a reflected wave, which is a wave that is the irradiation wave reflected by the object. Furthermore, for a distance measurement system, a position sensitive device (PSD) method using a PSD for a light receiving element may be used.

Alternatively, as another distance acquisition method, a method of calculating parallax from a stereo camera to obtain a distance map of a subject may be used. Alternatively, as another distance acquisition method, deep learning for estimating a depth from an image may be used. In this case, actual distance estimation may be performed, or a relative distance may be calibrated by measuring an actual distance by another method.

The distance information acquisition unit 137 may be configured to obtain distance information in a predetermined one or a plurality of distance measurement areas defined in advance in an image, or may be configured to obtain a distance map indicating a distribution of distance information on a large number of pixels or regions in the image.

The display unit 138 displays an image temporarily stored in the internal memory 140, an image or data stored in an external memory, a measurement position, a length of the measurement position, a setting screen of the image capturing apparatus 130, and the like. The display unit 138 includes a thin film transistor (TFT) liquid crystal display, an organic EL display, or an electronic viewfinder (EVF).

The operation unit 139 is, for example, a button, a switch, a key, a mode dial, or the like added to the image capturing apparatus 130, or a touch panel disposed on the display unit 138. Setting of an image capturing condition, a command of a shooting operation, and the like by the user are transmitted to the controller 143 via the operation unit 139.

The internal memory 140 includes a nonvolatile memory such as a ROM that stores a program and a system memory such as a RAM used by the controller 143 as a work memory for work. The internal memory 140 temporarily stores various types of setting information such as information on a focus position at the time of image capturing necessary for the operation of the image capturing apparatus 130, and an image obtained by the processing of the image processing circuit 135. The internal memory 140 may temporarily store image data and the like received by the network I/F 142 through communication with the image processing apparatus 150. The internal memory 140 includes, for example, a rewritable nonvolatile memory such as a flash memory or an SDRAM.

The external memory I/F 141 is an interface with a nonvolatile storage medium attachable to the body of the image capturing apparatus 130 or a nonvolatile storage medium fixed inside the image capturing apparatus. The external memory is, for example, an SD card, a CF card, or the like. The external memory I/F 141 stores, into a storage medium (external memory) attachable to the body of the image capturing apparatus 130, image data processed by the image processing circuit 135, and image data, analysis data, and the like received by the network I/F 142 through communication with the image processing apparatus 150. The external memory I/F 141 reads image data stored in the storage medium (external memory) attachable to the image capturing apparatus 130 at the time of reproducing the image data. The external memory I/F 141 can display the read image data on the display unit 138 or output the read image data to the outside of the image capturing apparatus 130.

The network I/F 142 of the image capturing apparatus 130 is a communication interface for transmitting and receiving, to and from an external apparatus (the image processing apparatus 150 in the present embodiment), an image generated by the image processing circuit 135 and associated information thereof. In the present embodiment, a wireless network 160 based on the Wi-Fi (registered trademark) standard is used as an example of a network. Note that communication using Wi-Fi (registered trademark) may be implemented via a router. The network I/F 142 may be implemented by a wired communication interface such as a USB or a LAN.

The controller 143 supervises information processing in the image capturing apparatus 130 and controls other units. The controller 143 includes a central processing unit (CPU), and performs overall control by controlling each unit of the image capturing apparatus 130 in accordance with a program stored in the internal memory 140. The controller 143 controls the AF control unit 136, the image capturing unit 131, and the distance information acquisition unit 137.

### Functional Configuration of Image Processing Apparatus

Next, the functional configuration of the image processing apparatus 150 will be described.

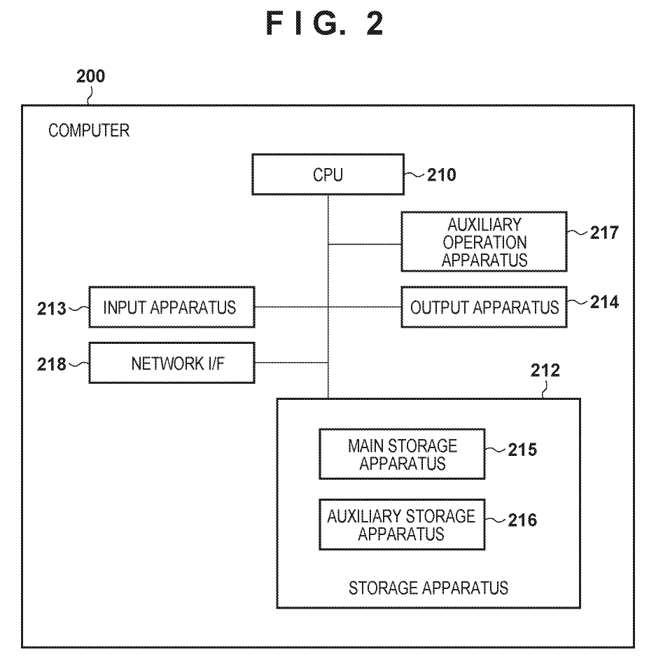

As described above, the image processing apparatus 150 is an apparatus that processes an image and distance information acquired by the image capturing apparatus 130. The image processing apparatus 150 includes functional units of a subject detection unit 151, a feature point detection unit 152, a measurement position information acquisition unit 153, a measurement position determination unit 154, a calculation unit 155, and an input/output unit 156. Each of these functional units is implemented by a CPU 210 described below with reference to FIG. 2 executing a program stored in a storage apparatus 212.

The subject detection unit 151 detects a type of a subject in an image (hereinafter called a captured image) received from the image capturing apparatus 130 via the input/output unit 156. The feature point detection unit 152 detects a feature point (also called a keypoint) from the subject in the captured image.

The measurement position information acquisition unit 153 acquires a measurement position set in advance for each subject. The measurement position determination unit 154 determines the measurement position of the subject based on the position of the detected feature point and information on the measurement position. The measurement position information includes information on a shape feature (position of a feature point) of a product and a measurement position based on the feature point, and is information defining which two points are to be measured based on the shape feature of the product. The measurement position information is template information for the measurement position, and the measurement position can be defined for a plurality of products having similar shape features. The calculation unit 155 calculates a length (called a measurement position length) between the measurement positions on the subject.

The input/output unit 156 inputs, into the image processing apparatus 150, an image, distance information, and the like acquired by the image capturing apparatus 130, and outputs, to the image capturing apparatus 130 and an external apparatus, a feature point position, a measurement position, a measurement position length, and the like detected by the image processing apparatus 150.

### Hardware Configuration of Image Processing Apparatus

Next, the hardware configuration of the image processing apparatus 150 in the first embodiment will be described with reference to FIG. 2. Each of the functional units of the image processing apparatus 150 illustrated in FIG. 1 is implemented by a computer 200.

The computer 200 includes the CPU 210, an auxiliary operation apparatus 217, the storage apparatus 212, an input apparatus 213, an output apparatus 214, and a network I/F 218.

The storage apparatus 212 includes a main storage apparatus 215 and an auxiliary storage apparatus 216. The main storage apparatus 215 includes a nonvolatile memory such as a ROM that records a program and a system memory such as a RAM used by the CPU 210 as a work memory for work. The auxiliary storage apparatus 216 is, for example, a magnetic disk apparatus, a solid state drive (SSD), or the like.

The input apparatus 213 is, for example, a mouse, a keyboard, or the like. Note that the image processing apparatus 150 may include, as the input apparatus 213, a touch panel display or the like in which a touch panel is integrally configured with the output apparatus 214. The output apparatus 214 is, for example, a computer display.

The network I/F 218 of the image processing apparatus 150 transmits and receives, to and from an external apparatus (the image capturing apparatus 130 in the present embodiment), an image generated by the image processing circuit 135 and associated information thereof.

The network I/F 218 may be configured as a wireless communication module for performing communication using Wi-Fi (registered trademark).

The auxiliary operation apparatus 217 is an auxiliary operation IC used under the control of the CPU 210. As the auxiliary operation apparatus 217, a graphic processing unit (GPU) can be used as an example. Since a GPU includes a plurality of product-sum operators and is good at matrix calculation, the GPU is generally used as a processor that performs processing for deep learning. Note that as the auxiliary operation apparatus 217, a field-programmable gate array (FPGA), an ASIC, or the like may be used.

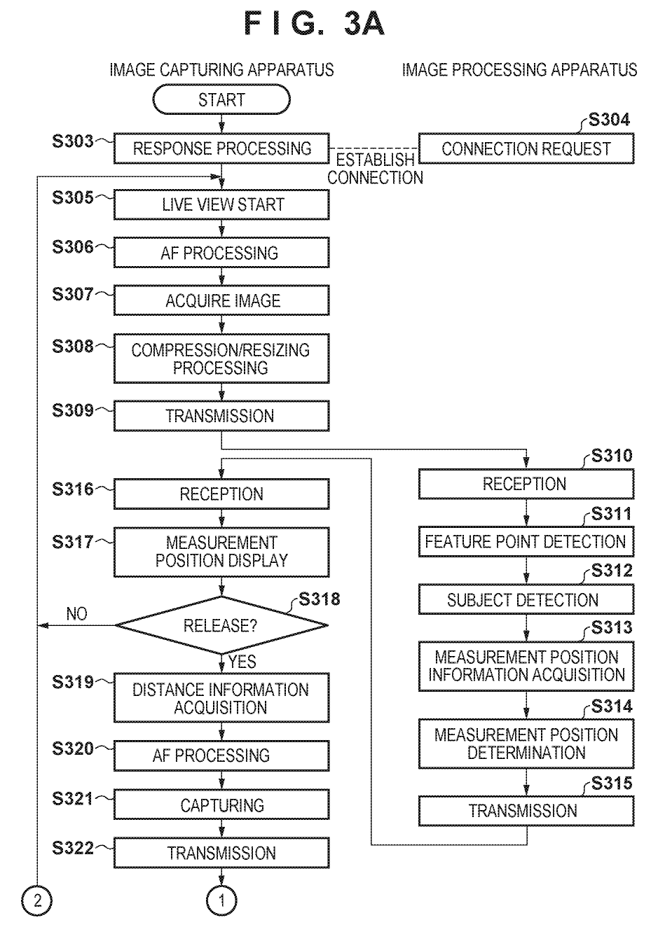

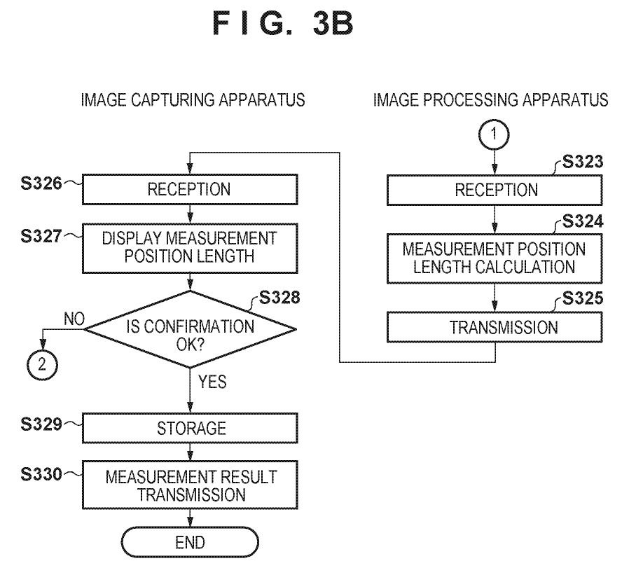

By executing a program stored in the storage apparatus 212, the CPU 210 functions as the subject detection unit 151, the feature point detection unit 152, the measurement position information acquisition unit 153, the measurement position determination unit 154, the calculation unit 155, and the output unit 156 of the image processing apparatus 150 of FIG. 1. Furthermore, the CPU 210 controls the order in which the above-described functional units operate. Note that the image processing apparatus 150 may include one or a plurality of the CPUs 210 and the storage apparatuses 212. That is, at least one processing apparatus (CPU) is connected to at least one storage apparatus, and the at least one processing apparatus executes a program stored in the at least one storage apparatus, whereby the image processing apparatus 150 functions as each of the above-described functional units. Note that the processing apparatus is not limited to the CPU, and may be an FPGA, an ASIC, or the like. Next, the operation of the image processing system 110 of the present embodiment will be described with reference to the flowchart shown in FIGS. 3A and 3B.

In FIGS. 3A and 3B, step is denoted as S. That is, for example, step S303 is denoted as S303. Processing described on the left side is processing by the image capturing apparatus 130, and processing described on the right side is processing by the image processing apparatus 150.

First, in steps S303 (response processing) and S304 (connection request), the controller 143 of the image capturing apparatus 130 and the CPU 210 of the image processing apparatus 150 are connected to the network 160 of the Wi-Fi standard, which is a wireless LAN standard. In step S304, the image processing apparatus 150 makes a connection request to the image capturing apparatus 130 to be connected, and in step S303, the image capturing apparatus 130 performs response processing to this. Universal Plug and Play (UPnP) is used as an example of a method of searching for equipment via a network. Here, in UPnP, identification of individual apparatuses is performed by a universally unique identifier (UUID).

When a connection with the image processing apparatus 150 is established, the controller 143 of the image capturing apparatus 130 starts live view processing in step S305 (live view start).

In step S306 (AF processing), the controller 143 starts AF processing of driving and controlling the lens group 132 so as to focus on the subject using the AF control unit 136. In a case where focus position adjustment is performed by the contrast AF, distance information from the position of the focus lens in a focused state to the subject of the target that is focused is obtained.

In step S307 (image acquisition), the controller 143 acquires an image in which the subject is captured. The controller 143 generates image data by the image sensor 134, and applies to this image data development processing necessary for the image processing circuit 135 to generate image data for live view display. By repeatedly performing the processing, a live view video with a predetermined frame rate is displayed on the display unit 138. Note that the controller 143 repeatedly performs the AF processing together with the display of the live view video until detecting that a release button is pressed in step S318 described later.

In step S308 (compression/resizing processing), the controller 143 performs development and compression processing by the image processing circuit 135 on any image data captured for live view and acquired in step S307. Then, for example, image data of the JPEG standard is generated. Furthermore, the resizing processing is performed on the compressed image data, and the size of the image data is reduced.

In step S309 (transmission), the controller 143 transmits (outputs) the image data acquired by the live view to the image processing apparatus 150 by the network I/F 142.

Here, processing by the image processing apparatus 150 will be described.

In step S310 (reception), the CPU 210 of the image processing apparatus 150 receives (acquires) the captured image output from the network I/F 142 of the image capturing apparatus 130 by the network I/F 218.

In step S311 (feature point detection), the CPU 210 detects a feature point or a line segment on the captured image received in step S310 by the feature point detection unit 152. Feature point detection is also called keypoint detection. The feature point detection is also called pose estimation depending on an application range, and is a technique of detecting a plurality of feature point positions (keypoints) from an input image and capturing the entire image. The keypoint detection is often used as pose estimation by being applied to an image of a human body, but if a feature of a point of an object is known, it can be applied to an object other than the human body.

In the present embodiment, deep learning is used for keypoint detection. In a plurality of images, by causing a learning model to learn in advance the position of the feature point to be detected as learning data, it is possible to intentionally control the feature point position to be detected.

In the present embodiment, a corner portion and a curved portion are detected as feature point positions with respect to a subject such as a bag, a top, bottoms, a watch, or a piece of jewelry. Note that the subject is not limited to the above object. The method of installing the subject includes hanger display and torso, or may be other methods.

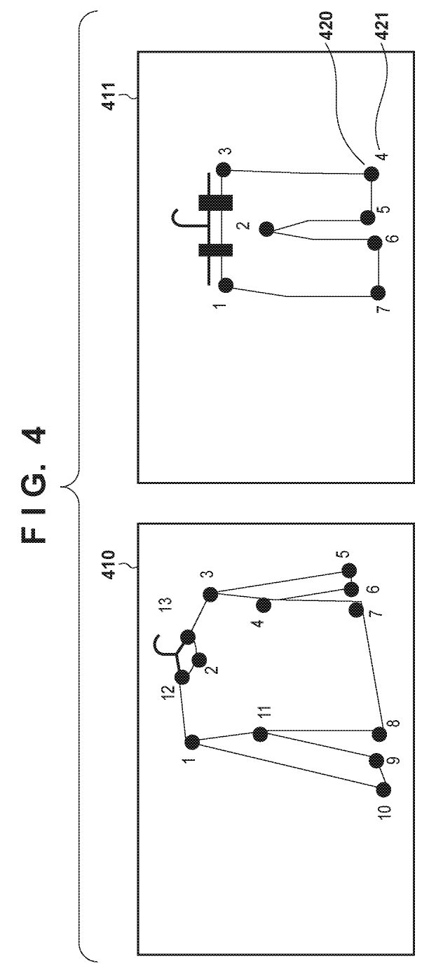

FIG. 4 is a view illustrating an example of feature point position detection. As an example, feature point positions with respect to images of a top 410 and bottoms 411 are illustrated. A feature point position 420 is displayed by a circle mark, and an identification number (feature point ID) 421 is assigned to each feature point. Note that the feature point detection unit 152 may detect a line segment connecting two feature points.

In step S312 (subject detection), the CPU 210 detects the type of the subject of a captured image by the subject detection unit 151. The present embodiment uses a task of object detection of deep learning for subject detection. Note that detection of the subject type may be by a rule-based determination method based on an image feature amount.

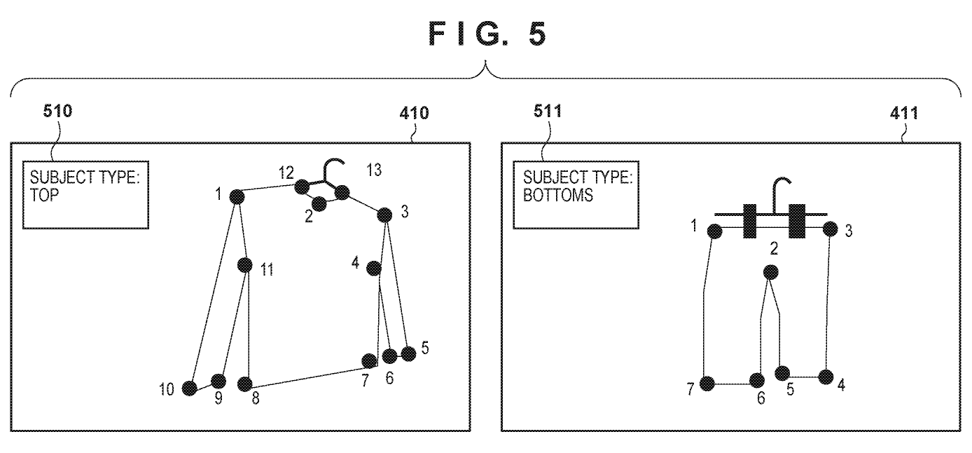

FIG. 5 is a view illustrating an example of detection of a subject type in the first embodiment.

Results of identification of the subject types for the images of the top 410 and the bottoms 411 are expressed in 510 and 511, respectively.

Note that as described above, the subject is not limited to these, and may be a subject such as a bag, a top, bottoms, a watch, or a piece of jewelry, and in a case where an object detection model of deep learning is used, an expected subject can be learned in advance so that it can be recognized.

In step S313 (measurement position information acquisition), the CPU 210 acquires the measurement position information stored in advance in the storage apparatus 212 by the measurement position information acquisition unit 153. The measurement position information is information defining a position to be measured from the shape feature of each subject.

The measurement position information includes a shape feature (feature point) of a product and information on a measurement position based on the feature point, and in the present embodiment, as an example, the measurement position information is a database and includes a measurement position set table and a measurement position flat sketch table.

The measurement position set table is a table for determining a measurement position set based on information related to a product in a case where the subject is an e-commerce (EC) product. The measurement position set is information in which a plurality of measurement positions are defined for a certain flat sketch. The measurement position flat sketch table is information defining a plurality of line segment positions to be measured from the shape feature of the subject by using the flat sketch for a plurality of measurement position sets.

Note that the measurement position information acquisition unit 153 may perform processing of correcting the orientation of a captured image and displaying the captured image based on the acquired distance information.

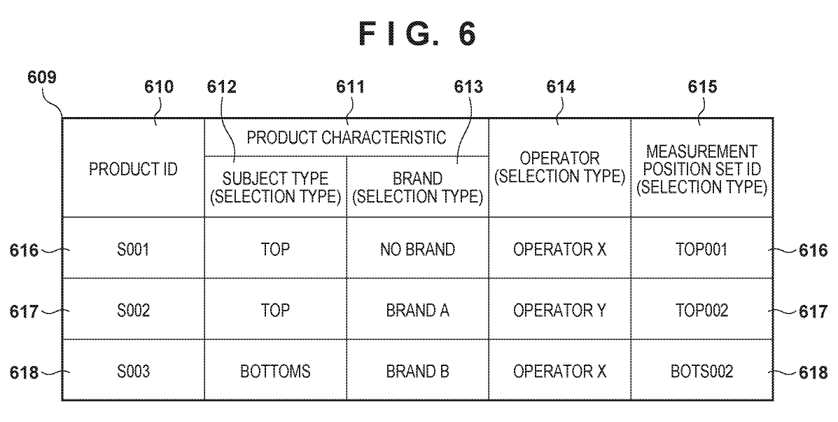

An example of the measurement position set table will be described with reference to FIG. 6.

A measurement position set table 609 includes, as columns, a product ID 610, a product characteristic 611, an operator 614, and a measurement position set ID 615.

The product ID 610 is an individual number for identifying a product. The product characteristic 611 is information indicating a characteristic of a product. In the present embodiment, a subject type 612 and a product brand 613 are provided as examples. The column of the product characteristic is not limited to the items exemplified here. The operator 614 is an operator that performs measurement.

The measurement position set is information in which a plurality of measurement positions are defined for a certain flat sketch as described above, and in the present table, the measurement position set ID 615 is input as ID information for specifying the measurement position set.

The purpose of the measurement position set table is to determine a measurement position set based on information related to the product, and the operator can set the measurement position set in accordance with a policy for each operator by information set in advance in the operator 614 and the product characteristic 611.

Specifically, whether to determine the measurement position set for each individual product ID, by the subject type, or by the subject type and the brand can be selected by using the present table in accordance with a rule defined by the operator itself.

In the present embodiment, an example of the method of determining a measurement position set from each product based on the measurement position set table 609 will be described.

In products S001 to S003, first, since the flat sketch varies depending on the subject type 612, the measurement position set corresponding to the subject type is selected. The products S001 and S002, whose subject type is top, are assigned a measurement position set for tops, and the product S003, whose subject type is bottoms, is assigned a measurement position set for bottoms.

Both the products S001 and S002 are tops, but the product S001 is of an operator X, the product S002 is of an operator Y, i.e., the operators are different. Since there is a difference in measurement position policies depending on the difference in the operators, the measurement position sets vary depending on the operators, and the measurement position sets are defined as TOP001 for the product S001 and TOP002 for the product S002.

Note that which operator to employ is set in advance by the input apparatus 213 for the image processing apparatus 150 and stored in the storage apparatus 212. The product ID and the product characteristic information associated with the product may be inputtable as appropriate from the image capturing apparatus 130 and the image processing apparatus 150.

The measurement position information having such a configuration enables a measurement position to be determined in detail by the operator or the brand.

Note that in the present embodiment, the subject type 612 and the brand 613 are used as information for determining the product ID 610 and the measurement position set. However, as another example, a product ID may be separately acquired in cooperation with a barcode reader, and a measurement position set associated with the product ID on a one-to-one basis may be used. The barcode may be shot by not the barcode reader but the image capturing apparatus 130, the ID may be parsed by the image capturing apparatus 130 or the image processing apparatus 150, and a measurement position set may be determined by checking against a measurement position set DB.

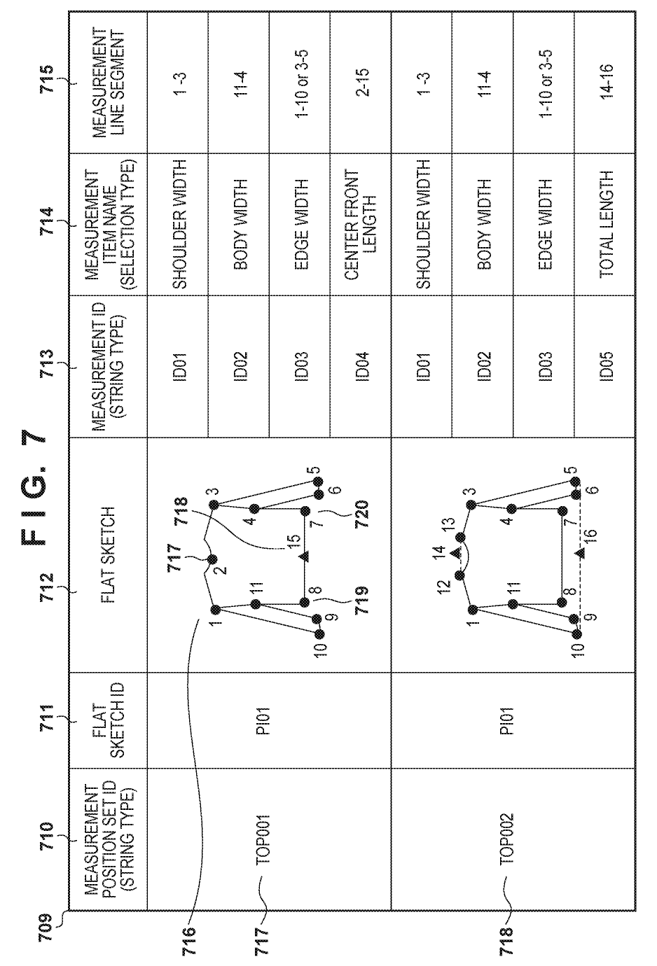

Next, an example of the measurement position flat sketch table will be described with reference to FIG. 7.

A measurement position flat sketch table 709 includes, as columns, a measurement position set ID 710, a flat sketch ID 711, a flat sketch 712, a measurement ID 713, a measurement item name 714, and a measurement line segment 715.

The measurement position set ID 710 is an ID of a measurement position set. The measurement position set is information in which a plurality of measurement positions are defined based on a measurement position set flat sketch and a shape feature of the flat sketch.

The flat sketch ID 711 is an ID for identifying the flat sketch 712. The flat sketch 712 stores figure information as a flat sketch. In the present embodiment, the flat sketch 712 is stored as a figure in vector format. Since the measurement position is calculated from a shape feature, size information needs not be included.

The flat sketch 712 includes measurement position information. The measurement position information is determined for each measurement position set ID, and even if the flat sketch is the same, the measurement position information is not necessarily the same as long as the measurement position set ID is different. The measurement position information is assigned a measurement position ID corresponding to the feature point ID in feature point position detection. In a flat sketch example 716, the position represented by a circle mark 717 is a measurement position detected by the feature point position detection in step S311.

The position represented by a triangle mark 718 is a measurement position calculated from the feature point position. The position of the triangle mark 718 is calculated as an intermediate position between a measurement position 719 (measurement position ID is 8) and a measurement position 720 (measurement position ID is 7). Such a method of calculating a calculated measurement position is separately managed by table information (not illustrated) based on the measurement position set. Note that the measurement position set ID may include flat sketches of an identical object from various viewpoints.

Note that in the present embodiment, the flat sketch is a planar figure, but may be defined as a non-planar 3D model, and the measurement position may be defined in a three-dimensional space.

The measurement ID 713 is an ID of a line segment configured by selecting two points from the measurement positions of the flat sketch 712. The measurement item name 714 designates the name of the measurement item. The measurement line segment 715 designates two measurement position IDs defined corresponding to the measurement positions, and determines a line segment position to be measured.

In this manner, the measurement position flat sketch table 709 defines a plurality of line segment positions to be measured from the shape feature of the subject by using a flat sketch.

Note that TOP001 (717) and TOP002 (718) of the measurement position set ID have the same flat sketch, but the positions of the measurement line segments are different. The former is about measuring the center front length, whereas the latter is about measuring the total length. In this manner, the position of the measurement line segment can be finely designated for each measurement position set ID.

In step S314 (measurement position determination), using the measurement position determination unit 154, the CPU 210 determines the measurement position on the captured image by matching the feature point ID by the feature point detection result in step S311 with the measurement position ID of the measurement position information acquired in step S313.

Specifically, a line segment of the feature point ID on the subject image corresponding to the measurement position ID constituting the measurement line segment in the measurement position set table (FIG. 7) is determined as a measurement position.

Returning to the description of FIG. 3, in step S315 (transmission), the CPU 210 of the image processing apparatus 150 transmits, by wireless communication to the image capturing apparatus 130, information on the type of the subject, the measurement position information, an image on which the measurement position information is superimposed and displayed, and the like by the network I/F 218.

Here, processing by the image capturing apparatus 130 will be described.

In step S316 (reception), the controller 143 of the image capturing apparatus 130 receives the information transmitted from the image processing apparatus 150 in step S315 by the network I/F 142.

In step S317 (measurement position display), the controller 143 displays a live view image in a state where the measurement position is superimposed on the display unit 138 based on the information received in step S316.

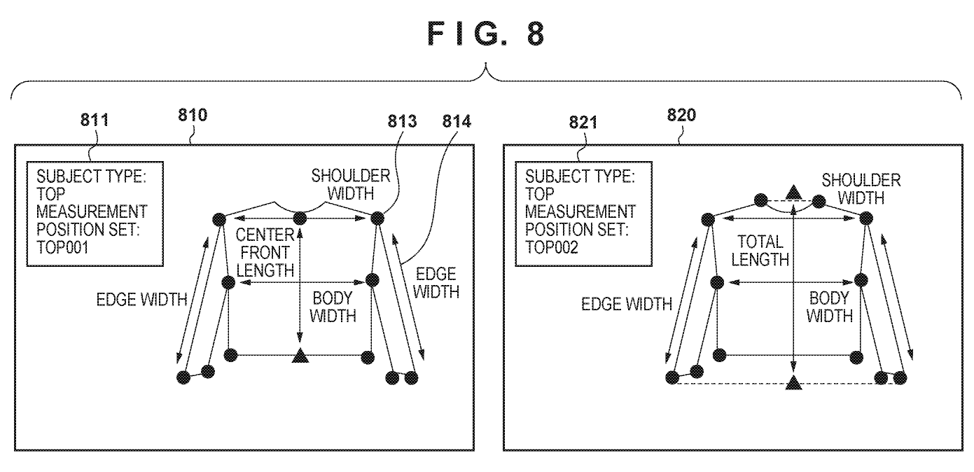

FIG. 8 illustrates an example of display on the display unit 138.

A display example 810 is an example in which the measurement position to which TOP001 is applied as the measurement position set is superimposed and displayed on the live view image. The display unit 138 displays text information 811 such as the subject type and the measurement position set. A measurement position 813 displayed by a circle and a line segment 814 for measuring the measurement length are displayed. Since the measurement position can also be understood as an end point of the measurement length, the measurement position 813 may be omitted.

A display example 820 is an example in which the measurement position to which the measurement position set of TOP002 is applied is superimposed and displayed on the live view image. In text information 821, TOP002 is displayed as the measurement position set, and the measurement position corresponding to it is superimposed and displayed on the live view image.

By displaying the measurement position in the live view image in this manner, it is possible to try shooting after confirming the measurement position before the shooting.

Note that the image capturing apparatus 130 can adjust the feature point position based on a user's instruction via the operation unit 139 of the image capturing apparatus 130. In a case where the measurement position is different from an expected position, the image capturing apparatus 130 recognizes a difference between the feature point position to be detected and the designated position to be input from the touch panel included in the operation unit 139 of the image capturing apparatus 130, and offsets it to the feature point detection position, thereby finely adjusting the measurement position.

Note that in a case where the measurement position is different from the expected position, the measurement position may be configured to be finely adjustable from the touch panel included in the operation unit 139 of the image capturing apparatus 130. The measurement position can be finely adjusted by recognizing the feature point position to be detected and the measurement position to be input from the touch panel. Note that the adjustment means may be included in the image processing apparatus.

‎ In step S318 (Release?), the controller 143 detects whether or not the release button included in the operation unit 139 has been pressed. If the release button has not been pressed, the image capturing apparatus 130 returns to the processing of step S305 and continues the live view display. If the release button has been pressed, the image capturing apparatus 130 proceeds to the processing of step S319.

In step S319 (distance information acquisition), the controller 143 acquires a plurality of subject distances based on the measurement position information by the distance information acquisition unit 137.

### Distance Acquisition Method 1

In the present embodiment, automatic focus adjustment (AF) is performed on a plurality of measurement positions, and each piece of distance information is acquired based on the position of the focus lens, whereby a plurality of pieces of subject distance information is acquired in a short time. Note that AF to the plurality of measurement positions may be continuously performed.

### Distance Acquisition Method 2

As another distance acquisition method, distance information may be acquired from focus bracket shooting. In the focus bracket shooting, a plurality of images are acquired at a high speed by slightly changing the focus position, and depth synthesis is performed, thereby acquiring an entirely focused image of an object with depth.

Using this, the image capturing unit performs image capturing while shifting the position of the focus lens, and the distance information acquisition unit 137 acquires the distance information on the subject based on a shot image of each frame (and a focusing region in an image plane) and the focus lens position of the frame corresponding thereto. From this distance information, a point close to the measurement position or a point interpolated from surrounding distance measurement points is used as distance information at the measurement position.

### Distance Acquisition Method 3

As another distance acquisition method, the distance to the subject may be acquired by the phase difference method as described above. From this distance information, a point close to the measurement position or a point interpolated from surrounding distance measurement points is used as distance information at the measurement position.

### Distance Acquisition Method 4

As another distance acquisition method, the distance information may be acquired using the TOF sensor as described above. From this distance information, a point close to the measurement position or a point interpolated from surrounding distance measurement points is used as distance information at the measurement position.

### Distance Acquisition Method 5

As another distance acquisition method, a method of calculating parallax from a stereo camera to obtain a distance map of a subject may be used. From this distance information, a point close to the measurement position or a point interpolated from surrounding distance measurement points is used as distance information at the measurement position.

### Distance Acquisition Method 6

As another distance acquisition method, deep learning for estimating the depth from an image may be used. In this case, actual distance estimation may be performed, or a relative distance may be calibrated by measuring an actual distance by another method. From this distance information, a point close to the measurement position or a point interpolated from surrounding distance measurement points is used as distance information at the measurement position.

Note that these plurality of distance acquisition methods may be used in combination. The acquired distance information is stored in the internal memory 140.

In step S320 (AF processing), the controller 143 performs AF processing by driving and controlling the lens group 132 such that AF control unit 136 focuses on the subject. Note that the AF processing in the present step may be replaced with the distance information acquisition processing to be performed in step S319.

In step S321 (image capturing), the controller 143 captures a still image using the image capturing unit 131. Note that in step S321 (image capturing), in order to acquire an image with less AF shift, it is desirable to perform AF at a preferable position as a subject video at a timing close to image capturing.

In step S322 (transmission), the controller 143 transmits (outputs), to the image processing apparatus 150 by the network I/F 142, the distance information acquired in step S319, focal length information on the lens group 132, and the captured image acquired in step S321.

Here, processing by the image processing apparatus 150 will be described.

In step S323 (reception), the CPU 210 of the image processing apparatus 150 receives (acquires) the information output from the network I/F 142 of the image capturing apparatus 130 by the network I/F 218.

In step S324 (length calculation of measurement position), the CPU 210 of the image processing apparatus 150 calculates the length (dimension) between the measurement positions by the calculation unit 155. The measurement position on the image is applied to a perspective projection model using the distance information, the focal length, and principal point position information on the lens acquired by the AF at the plurality of positions on the subject. By this, a three-dimensional positional relationship of the measurement positions in a camera coordinate system is obtained.

The measurement position length can be obtained as an actual distance from the three-dimensional distance between the measurement positions in this camera coordinate system. Since the distance between the measurement positions is actually measured along the surface of the subject, the three-dimensional shape corresponding to the flat sketch 712 may be stored, and the length between the two measurement positions may be interpolated and measured. This can improve the measurement accuracy of the measurement position length.

Note that in a case where a continuous distance map is acquired by a stereo camera, a phase difference method, or the like, the distance between two points of the measurement position on the distance map may be three-dimensionally measured.

In step S322 (transmission), the CPU 210 of the image processing apparatus 150 transmits, by wireless communication to the image capturing apparatus 130, information on the measurement position length, an image on which the information on the measurement position length is superimposed and displayed, and the like by using the network I/F 218.

In step S326 (reception), the controller 143 of the image capturing apparatus 130 receives the information transmitted from the image processing apparatus 150 in step S325 by the network I/F 142.

Here, processing by the image capturing apparatus 130 will be described.

In step S327 (measurement position length display), the controller 143 displays, on the display unit 138, an image in which the length of the measurement position is superimposed and displayed on a captured image, based on the information received in step S326.

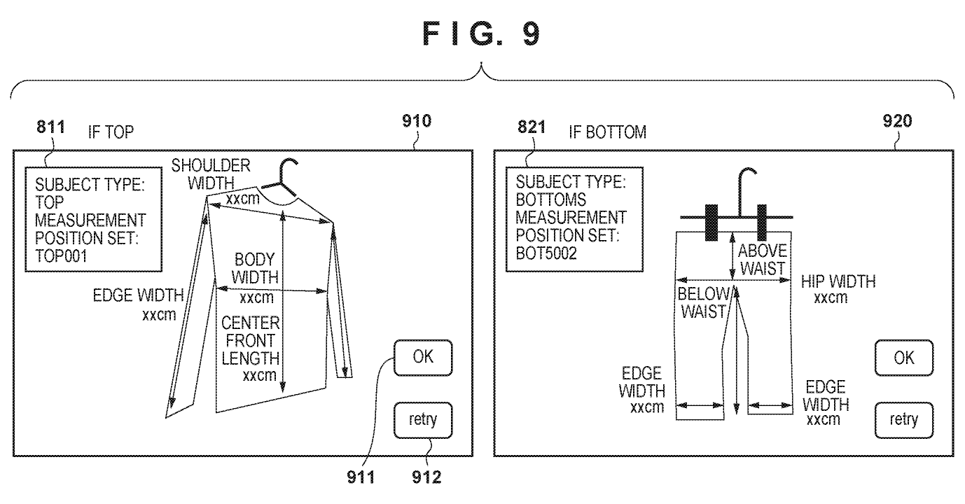

FIG. 9 illustrates an example of display on the display unit 138. A display example 910 is an example of displaying the measurement position length of the top. The display unit 138 displays an OK button 911 and a retry button 912. A display example 920 is an example of displaying the measurement position length of the bottoms.

‎ In step S328 (Confirmation OK?), the user confirms a measurement result of the measurement position length, and presses, via the operation unit 139, the OK button if it is OK, or presses the retry button if re-shooting is necessary.

The processing transitions to step S329 in a case where OK is pressed, and the processing transitions to step S305 (live view start) in a case where retry is pressed and the processing returns to the live view display.

In step S329 (storage), the controller 143 stores the captured image and the measurement result of the measurement position length into the internal memory 140. An image in which the measurement result is superimposed on the image is generated and stored. The measurement result is stored together with the measurement position information as an associated information file. The associated information file may be any of xml format, json format, csv format, and text file.

In step S330 (measurement result transmission), the controller 143 transmits the data stored in step S329 to an external apparatus (illustrated) that is a data usage destination.

As described above, according to the present embodiment, it is possible to provide an image processing apparatus that can determine a measurement position without manually selecting two points.

### Second Embodiment

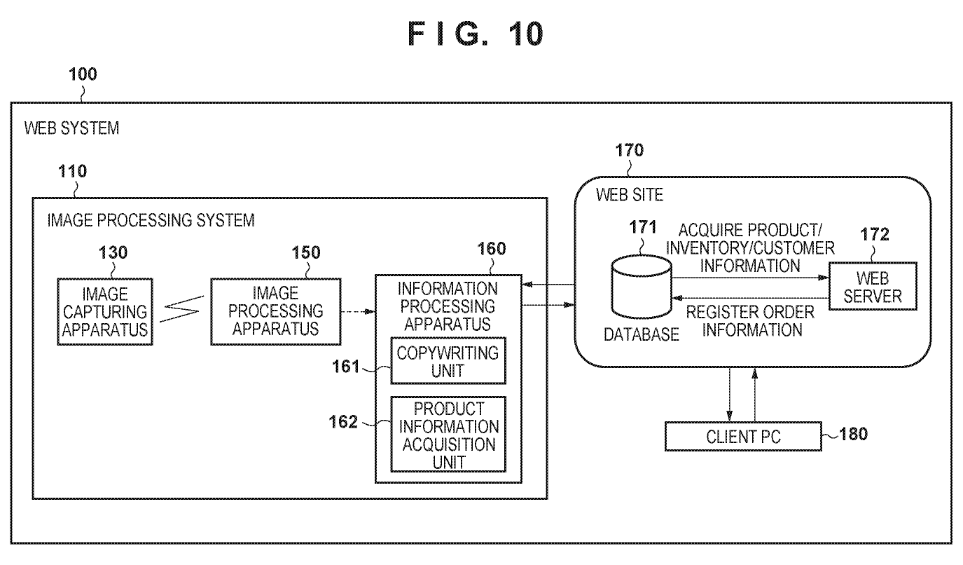

Hereinafter, a Web system according to the second embodiment of the present disclosure will be described with reference to FIG. 10. The Web system illustrated in FIG. 10 is the image processing system described in the first embodiment provided with an information processing apparatus 160, and also provided with a Web site 170 and a client PC 180.

In the present embodiment, an image and a measurement result acquired by the image processing apparatus 150 are transmitted to the information processing apparatus 160, and the information processing apparatus 160 registers, to a Web site, them in association with product information and the like. This enables web shopping to be performed by operating an EC site on the Web site 170 and accessing the Web site with the client PC 180.

The information processing apparatus 160 is a PC used by the operator. The information processing apparatus 160 includes a copywriting unit 161 and a product information acquisition unit 162. The information processing apparatus 160 receives a captured image to be output from the image processing apparatus 150 and a measurement result of the measurement position length, and transmits them to the Web site 170 in association with product information to be acquired by the product information acquisition unit 162. Here, the copywriting unit 161 creates a copy based on the measurement information and the product information, stores and transmits, to the Web site 170, the image and the product information in association with the copy. This can improve efficiency of copywriting, which is one of the tasks in the EC industry.

The Web site 170 includes a database 171 and a Web server 172. The Web site functions as an EC site for web shopping. The database 171 stores a plurality of product images, pieces of product information, and the like received from the operator PC 160.

A Web application is deployed on the Web server 172, and the Web application accesses the database 171, acquires a plurality of product images and pieces of product information, and causes the EC site to operate. The client PC 180 is operated by a client, and performs Web shopping by accessing the EC site.

According to the present embodiment, by efficiently using a measurement result generated by the image processing system for copywriting, it is possible to improve the efficiency of the tasks of "shooting", "measuring", and "copywriting".

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-007981, filed January 20, 2025, which is hereby incorporated by reference herein in its entirety.

What is claimed is:

1. An image processing system in which an image capturing apparatus that captures a subject and an image processing apparatus that processes an image captured by the image capturing apparatus are communicably configured, wherein
the image processing apparatus includes
at least one processor or circuit and a memory storing instructions to cause the at least one processor or circuit to perform operations of the following units:
a first detection unit that detects a feature point of the subject or a line segment connecting feature points from the image;
a second detection unit that detects a type of the subject from the image;
an acquisition unit that acquires information on a measurement position of the subject based on the type of the subject;
a determination unit that determines the measurement position of the subject based on the feature point or the line segment and the information on the measurement position; and
a calculation unit that calculates an actual dimension between the measurement positions.

2. The image processing system according to claim 1, wherein the image capturing apparatus includes a third detection unit that detects a distance to the subject.

3. The image processing system according to claim 2, wherein the third detection unit performs automatic focus adjustment on the subject, and detects the distance of the subject from the image capturing apparatus based on a position of a focus lens after the automatic focus adjustment is performed.

4. The image processing system according to claim 2, wherein the third detection unit performs image capturing while shifting a position of a focus lens in the image capturing apparatus, and detects the distance of the subject from the image capturing apparatus based on an image of each frame and a position of the focus lens corresponding to the image.

5. The image processing system according to claim 2, wherein the image capturing apparatus includes an image sensor having a plurality of photoelectric conversion regions in a pixel, and the third detection unit detects the distance to the subject based on an image shift amount between two images formed by light fluxes that have passed through different pupil regions in the plurality of photoelectric conversion regions.

6. The image processing system according to claim 2, wherein the calculation unit calculates the actual dimension between the measurement positions based on information on a distance of the measurement position from the image capturing apparatus.

7. The image processing system according to claim 1, wherein the at least one processor or circuit of the image capturing apparatus is configured to further function as an adjustment unit that adjusts a position of the feature point based on a user's operation.

8. The image processing system according to claim 1, wherein the image processing apparatus further includes a unit that converts the information on the measurement position into text information.

9. The image processing system according to claim 8, wherein the image processing apparatus further includes a storage device that stores the image, the text information, and product information on the subject in association with one another.

10. The image processing system according to claim 1, wherein the image capturing apparatus further includes a display device that displays the image with the measurement position superimposed.

11. An image processing apparatus comprising:
at least one processor or circuit and a memory storing instructions to cause the at least one processor or circuit to perform operations of the following units:
an acquisition unit that acquires an image in which a subject is captured;
a first detection unit that detects a feature point of the subject or a line segment connecting feature points from the image;
a second detection unit that detects a type of the subject from the image;
an acquisition unit that acquires information on a measurement position of the subject based on the type of the subject;
a determination unit that determines the measurement position of the subject based on the feature point or the line segment and the information on the measurement position; and
a calculation unit that calculates an actual dimension between the measurement positions.

12. The image processing apparatus according to claim 11, wherein the calculation unit calculates the actual dimension between the measurement positions based on information on a distance of the measurement position from the image capturing apparatus that captured the subject.

13. The image processing apparatus according to claim 11, wherein the at least one processor or circuit is configured to further function as a unit that converts the information on the measurement position into text information.

14. The image processing apparatus according to claim 13 further comprising a storage device that stores the image, the text information, and product information on the subject in association with one another.

15. A method of controlling an image processing apparatus comprising:
acquiring an image in which a subject is captured;
detecting a feature point of the subject or a line segment connecting feature points from the image;
detecting a type of the subject from the image;
acquiring information on a measurement position of the subject based on the type of the subject;
determining the measurement position of the subject based on the feature point or the line segment and the information on the measurement position; and
calculating an actual dimension between the measurement positions.

16. A non-transitory computer-readable storage medium storing a program for causing a computer to execute each process of a method of controlling an image processing apparatus, the method comprising:
acquiring an image in which a subject is captured;
detecting a feature point of the subject or a line segment connecting feature points from the image;
detecting a type of the subject from the image;
acquiring information on a measurement position of the subject based on the type of the subject;
determining the measurement position of the subject based on the feature point or the line segment and the information on the measurement position; and
calculating an actual dimension between the measurement positions.
